(19) United States
(12) Patent Application Publication
(10) Pub. No.: US 2025/0374916 A1
(43) Pub. Date: Dec. 11, 2025

(54) ICE-FREE VITRIFICATION AND NANO-WARMING OF LARGE TISSUE SAMPLES

(71) Applicant: TISSUE TESTING TECHNOLOGIES LLC, North Charleston, SC (US)

(72) Inventors: Kelvin GM Brockbank, Charleston, SC (US); Zhen Zhen Chen, Mount Pleasant, SC (US)

(73) Assignee: TISSUE TESTING TECHNOLOGIES LLC, North Charleston, SC (US)

(21) Appl. No.: 19/310,608

(22) Filed: Aug. 26, 2025

Related U.S. Application Data
(63) Continuation of application No. 17/088,860, filed on Nov. 4, 2020.
(60) Provisional application No. 62/931,943, filed on Nov. 7, 2019.

(51) Int. Cl. A01N 1/125

(52) U.S. Cl. CPC A01N 1/125

(57) ABSTRACT

Large volume cellular material may be preserved by combining the cellular material with a cryoprotectant formulation/medium/solution containing at least one mNP and then subjecting the cellular material to a vitrification preservation protocol including nanowarming. This preservation method is particularly effective for cartilage tissues.

### CROSS-REFERENCE TO RELATED APPLICATION

This is a continuation of U.S. application Ser. No. 17/088,860, filed Nov. 4, 2020, which is a nonprovisional application of U.S. Provisional Application No. 62/931,943 filed Nov. 7, 2019. The disclosure of the prior application is hereby incorporated by reference in its entirety.

### STATEMENT REGARDING FEDERALLY SPONSORED RESEARCH

This invention was made with government support under Grant #AR073136 awarded by the National Institute of Arthritis and Musculoskeletal and Skin Diseases of the United States National Institutes of Health. The government has certain rights in the invention.

### TECHNICAL FIELD

The present disclosure relates to the field of cell, tissue and organ preservation, particularly the invention relates to a method of ice-free vitrification preservation of cellular materials in which nanowarming is applied in combination with an effective amount of mNPs, such as 2 mg/mL Fe mNPs, in an effort to enhance cell survival and tissue functions post-preservation.

### BACKGROUND

In order for samples, cells or tissues to be preserved, cryoprotectant solutions are typically used to prevent damage due to freezing during the cooling or thawing/warming process. For cryopreservation to be useful, the preserved sample should retain the integrity and/or viability thereof to a reasonable level post-preservation. Thus, the process of preserving the sample should avoid and/or limit the damage or destruction of the cells and/or tissue architecture.

Vitrification (i.e., cryopreserved storage in a “glassy” rather than crystalline phase) is an important enabling approach for tissue banking and regenerative medicine, offering the ability to store and transport cells, tissues and organs for a variety of biomedical uses. In ice-free cryopreservation by vitrification the formation of ice is prevented by the presence of high concentrations of chemicals known as cryoprotectants that both interact with and replace water and, therefore, prevent water molecules from forming ice.

While there have been recent advances in vitrifying tissues or organs, there are various challenges to successful rewarming of tissues or organs of a large volume. First, a rapid heating rate is needed to avoid any conditions that would allow for crystallization during warming. For example, depending on the cryoprotective agent materials/components employed, the sample must be heated faster than a critical warming rate to avoid ice formation. Second, uniform heating rates are desirable throughout the volume to avoid large thermal gradients, which can produce thermal stresses that cause fractures or cracks. Recently, silica-coated iron oxide nanoparticles suspended in VS55 have been used to successfully vitrify and re-warm human dermal fibroblast cells, porcine arteries and porcine aortic heart valve leaflet tissues. Volumes up to 80 ml were placed in a uniform alternating magnetic field (AMF) to heat the nanoparticles by magnetic hysteresis in a process known as nanowarming. See N. Manuchehrabadi et al., Improved tissue cryopreservation using inductive heating of magnetic nanoparticles, Sci. Transl. Med., 2017. While this approach has been used successfully to maintain the viability and function of cell and tissue samples, there is room for improvement particularly in terms of cell viability for materials preserved in the presence of high concentrations of cryoprotectants.

### SUMMARY OF THE INVENTION

It was found that supplementation of ice-free vitrification formulations having high concentrations of cryoprotectants, such as VS83, with an effective amount of mNPs, such as 2 mg/mL Fe mNPs, along with the use of nanowarming procedures described herein resulted in increased cell survival post-preservation and improved tissue functions.

The present application thus provides new methodology and new formulations for treatment of large volume cellular materials (including, for example, large blood vessels (e.g., a pulmonary artery), or cartilage) in which an effective amount of magnetic nanoparticles (mNPs), such as 2 mg/mL Fe mNPs, and optionally sugars, such as disaccharides (e.g., trehalose and/or sucrose) are added to ice-free vitrification cryoprotectant formulations. Supplementation with an effective amount of such components reduces the risk of ice formation during cooling and during rewarming, particularly when the nanowarming conditions described herein are applied.

### BRIEF DESCRIPTION OF THE DRAWINGS

FIGS. 1(A) and 1(B) are illustrations of data obtained with respect to how nanowarming maintains chondrocyte viability of porcine articular cartilage in 50 mL systems. FIG. 1(A) being an illustration of the viability of porcine articular cartilage normalized to the control (fresh tissue in growth media) as measured by the alamarBlue assay (N=2 for VS55; N=4 for VS70 and VS83); for each respective sample (starting from the sample on the far right (VS83+Fe): Day 4=1^{st} bar/col. from the far right side, Day 3=2^{nd} bar/col. from the far right side; Day 2=3^{rd} bar/col. from the far right side; Day 1=4^{th} bar/col. from the far right side, and Day 0=5^{th} bar/col. from the far right side; FIG. 1(B) being an illustration of the live and dead chondrocyte distribution across the porcine articular cartilage using the live/dead staining assay (Sigma) (Green/light grey: live cell; Red/dark grey: dead cell (N=4 for VS83; N=2 for fresh tissue).

FIG. 2 is an illustration of the data obtained with respect to the trypan blue exclusion results for cartilage (data shown as the mean±1 standard deviation, no significant differences were observed).

FIG. 3 is an illustration of the data obtained with respect to the GAG results for cartilage (GAG content was preserved in nanowarmed cartilage (N=4)).

FIG. 4 is an illustration of the data obtained with respect to the hypotonic permeability results for cartilage (both convection and nanowarmed cartilage demonstrated decreased permeability).

FIG. 5 is an illustration of the data obtained with respect to the aggregate modulus results for cartilage (convention (left), nano-warming (middle), and fresh (right)); nanowarmed cartilage appears similar to fresh cartilage (N=3).

FIG. 6 is an illustration of the data obtained with respect to the hydraulic permeability results for cartilage (convention (left), nano-warming (middle), and fresh (right)).

FIG. 7 is an illustration of the data obtained with respect to the vitrification strategies using convection warming.

FIG. 8 is an illustration of the data obtained with respect to the viability assessment after short-term and long-term storage with nanowarming.

FIGS. 9(A) and 9(B) are illustrations of data obtained with respect to the burst pressure (FIG. 9(A), mmHg) and linear modulus (FIG. 9(A), PSI) of fresh versus ice-free vitrified arteries after storage and warming using either nanowarming or convection in a 37° C. bath (the results are the mean±1 se of 5-8 individual pulmonary arteries, statistically significant increases by two-tailed T-test compared with fresh untreated controls are indicated by X; No other significant differences were observed).

FIG. 10 is an illustration of pressure data (psi) plotted against radial strain yielding a stress-strain curve typical of soft tissue deformation (typical curve is illustrated); the linear region was used to generate a best line fit yielding the linear modulus (mmHg, and the maximum pressure recorded prior to rupture was used to estimate burst pressure (PSI).

### DETAILED DESCRIPTION

### Terminology and Definitions

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context.

As used herein, the term “about” used in connection with a quantity is inclusive of the stated value and has the meaning dictated by the context. For example, it includes at least the degree of error associated with the measurement of the particular quantity. When used in the context of a range, the modifier “about” should also be considered as disclosing the range defined by the absolute values of the two endpoints. For example, the range “from about 2 to about 4” also discloses the range “from 2 to 4.”

Unless otherwise expressly stated herein, the modifier “about” with respect temperatures (° C.) refers to the stated temperature or range of temperatures, as well as the stated temperature or range of temperatures+/−1-4% (of the stated temperature or endpoints of a range of temperatures) of the stated. Regarding cell viability and cell retention (%), unless otherwise expressly stated herein, the modifier “about” with respect to cell viability and cell retention (%) refers to the stated value or range of values as well as the stated value or range of values+/−1-3%. Regarding expression contents, such as, for example, with the units in either parts per million (ppm) or parts per billion (ppb), unless otherwise expressly stated herein, the modifier “about” with respect to cell viability and cell retention (%) refers to the stated value or range of values as well as the stated value or range of values+/−1-3%. Regarding expressing contents with the units μg/mL, unless otherwise expressly stated herein, the modifier “about” with respect to value in μg/mL refers to the stated value or range of values as well as the stated value or range of values+/−1-4%. Regarding molarity (M), unless otherwise expressly stated herein, the modifier “about” with respect to molarity (M) refers to the stated value or range of values as well as the stated value or range of values+/−1-2%. Regarding, cooling rates (° C./min), unless otherwise expressly stated herein, the modifier “about” with respect to cooling rates (° C./min) refers to the stated value or range of values as well as the stated value or range of values+/−1-3%.

Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Additionally, for example, +/−1-4% is to be read as indicating each possible number along the continuum between 1 and 4. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

As used herein, the term “room temperature” refers to a temperature of about 18° C. to about 25° C. at standard pressure. In various examples, room temperature may be about 18° C., about 19° C., about 20° C., about 21° C., about 22° C., about 23° C., about 24° C., or about 25° C.

As used herein, “cellular material” or “cellular sample” refers to living biological material containing cellular components, whether the material is natural or man-made and includes cells, tissues and organs, whether natural or man-made. Such terms also mean any kind of living material to be cryopreserved, such as cells, tissues and organs. In some embodiments, the cells, tissues and organs may be mammalian organs (such as human organs), mammalian cells (such as human cells) and mammalian tissues (such as human tissues).

As used herein, the term “organ” refers to any organ, such as, for example, liver, lung, kidney, intestine, heart, pancreas, testes, placenta, thymus, adrenal gland, including large blood vessels (e.g., pulmonary artery), arteries, veins, lymph nodes, bone or skeletal muscle. As used herein, the term “tissue” or “tissues” comprises any tissue type comprising any kind of cell type (such as from one of the above-mentioned organs) and combinations thereof, including, for example, ovarian tissue, testicular tissue, umbilical cord tissue, placental tissue, connective tissue, cardiac tissue, tissues from muscle, cartilage and bone, endocrine tissue, skin and neural tissue. The term “tissue” or “tissues” may also comprise adipose tissue or dental pulp tissue. In some embodiments, the tissue or organ is obtained from a human such as a human liver, human lung, human kidney, human intestine, human heart, human pancreas, human testes, human placenta, human thymus, human adrenal gland, human arteries, human veins, human nerves, human skin, human lymph nodes, human bone or human skeletal muscle.

As used herein, the term “cell(s)” comprises any type of cell, such as, for example, somatic cells (including all kind of cells in tissue or organs), fibroblasts, keratinocytes, hepatocytes, cardiac myocytes, chondrocytes, smooth muscle cells, stem cells, progenitor cells, oocytes, and germ cells. Such cells may be in the form of a tissue or organ. In some embodiments, the cells are from a mammal tissue or organ, such as a human tissue or organ described above.

As used herein, “preservation protocol” refers to a process for provision of shelf life to a cell containing, living biological material. Preservation protocols may include cryopreservation by vitrification and/or anhydrobiotic preservation by either freeze-drying or desiccation.

As used herein, the term “vitrification” refers to solidification either without ice crystal formation or without substantial ice crystal formation. In some embodiments, a sample to be preserved (e.g., such as a tissue or cellular material) may be vitrified such that vitrification and/or vitreous cryopreservation (in its entirety-from initial cooling to the completion of rewarming) may be achieved without any ice crystal formation. In some embodiments, a sample to be preserved (e.g., such as a tissue or cellular material) may be vitrified such that vitrification and/or vitreous cryopreservation may be achieved where the solidification of the sample to be preserved (e.g., such as a tissue or cellular material) may occur without substantial ice crystal formation (i.e., the vitrification and/or vitreous cryopreservation (in its entirety-from initial cooling to the completion of rewarming) may be achieved even in the presence of a small, or restricted amount of ice, which is less than an amount that causes injury to the tissue).

As used herein, a sample to be preserved (e.g., such as an organ, a tissue or cellular material) is vitrified when it reaches the glass transition temperature (Tg). The process of vitrification involves a marked increase in viscosity of the cryoprotectant solution as the temperature is lowered such that ice nucleation and growth are inhibited. Generally, the lowest temperature a solution can possibly supercool to without freezing is the homogeneous nucleation temperature Tₕ, at which temperature ice crystals nucleate and grow, and a crystalline solid is formed from the solution. Vitrification solutions have a glass transition temperature T_{g}, at which temperature the solute vitrifies, or becomes a non-crystalline solid.

As used herein, the “glass transition temperature” refers to the glass transition temperature of a solution or formulation under the conditions at which the process is being conducted. In general, the methodology of the present disclosure is conducted at physiological pressures. However, higher pressures can be used as long as the sample to be preserved (e.g., such as a tissue or cellular material) is not significantly damaged thereby.

As used herein, “physiological pressures” refer to pressures that tissues undergo during normal function. The term “physiological pressures” thus includes normal atmospheric conditions, as well as the higher pressures that various tissues, such as vascularized tissues, undergo under diastolic and systolic conditions.

As used herein, the term “cryoprotectant” means a chemical that minimizes ice crystal formation in and around a tissue/organ when the tissue is cooled to subzero temperatures and results in substantially no damage to the tissue/organ after warming, in comparison to the effect of cooling without cryoprotectant.

As used herein, the term “sugar” may refer to any sugar. In some embodiments, the sugar is a polysaccharide. As used herein, the term “polysaccharide” refers to a sugar containing more than one monosaccharide unit. That is, the term polysaccharide includes oligosaccharides such as disaccharides and trisaccharides, but does not include monosaccharides. The sugar may also be a mixture of sugars, such as where at least one of the sugars is a polysaccharide. In some embodiments, the sugar is at least one member selected from the group consisting of a disaccharide and a trisaccharide. In some embodiments, the sugar is a disaccharide, such as, for example, where the disaccharide is at least one member selected from the group consisting of trehalose and sucrose. In some embodiments, the sugar is a trisaccharide, such as raffinose. The sugar may also be a combination of trehalose and/or sucrose and/or raffinose and/or other disaccharides or trisaccharides. In some embodiments, the sugar comprises trehalose.

As used herein, the term “functional after cryopreservation” in relation to a cryopreserved material means that the cryopreserved material, such as organs or tissues, after cryopreservation retains an acceptable and/or intended function after cryopreservation. In some embodiments, the cellular material after cryopreservation retains all its indented function. In some embodiments, the cellular cryopreserved material preserved by the methods of the present disclosure retains at least 50% of the intended function, such as at least 60% of the intended function, such as at least 70% of the intended function, such as at least 80% of the intended function, such as at least 90% of the intended function, such as at least 95% of the intended function, such as 100% of the intended function. For example, along with preserving the viability of the cells, it may be important to also maintain/preserve the physiological function of the tissue/organ, e.g. for a heart the pumping function, and/or the ability of a tissue (e.g., those to be transplanted) to integrate with surrounding tissue.

As used herein, the term “sterile” means free from living germs, microorganisms and other organisms capable of proliferation.

As used herein, the term “substantially free of cryoprotectant” means a cryoprotectant in an amount less than 0.01 w/w %. In some embodiments, the methods of the present disclosure may use and/or achieve a medium/solution and/or cellular material that is substantially free of cryoprotectant, such as a cellular material that is substantially free of DMSO (i.e., the DMSO is in an amount less than 0.01 w/w %). In some embodiments, the methods of the present disclosure may use and/or achieve a medium/solution and/or cellular material that is substantially free of any cryoprotectant other than the sugar, such as sucrose and/or trehalose).

As used herein, the term “mNP” means nanoparticles that can be induced to generate heat by being placed in a magnetic (m) field and, in some embodiments, a collection of mNPs (hereinafter a collection of mNPs will be referred to simply as “mNPs”) will consist of nanometer scale Fe particles. In some embodiments, mNPs may be excitable by a radio frequency (i.e., RF susceptible nanoparticles), including, for example, alternating magnetic frequencies, or rotating magnetic frequencies. The mNPs can be nanoparticles that include one or more elements such as, for example, iron, and compounds containing atoms that generate heat when placed in a magnetic field

### Embodiments

This disclosure describes methodology and compositions involving rewarming and uniform heating of cryopreserved tissue samples (including, for example, large blood vessels (e.g., a pulmonary artery), or cartilage) that have been preserved in a high concentration CPA formulation, such as VS83. This results in lower thermal stresses (e.g., avoiding cracks) and little or no devitrification (e.g., avoiding crystals) on the cryopreserved sample, which affords improved cell viability, aggregate modulus and hydraulic permeability.

The present disclosure is directed to methods for preserving living materials/samples/organ(s)/tissue(s) (The terms “materials,” “samples,”, “organ(s)”, and “tissue(s)” are used interchangeably and encompass any living biological material containing cellular components). In some embodiments, the living materials/samples/organ(s)/tissue(s) being preserved may be of a “large volume” as used in the phrase “large volume cellular material” or “large volume sample” or “large volume cellular sample”. This refers to living biological materials containing cellular components, whether the material is natural or man-made and includes cellular materials, tissues and organs, whether natural or man-made, where such living biological material (including, for example, large blood vessels (e.g., a pulmonary artery), or cartilage) containing cellular components has a volume greater than about 4 mL, such as a volume greater than about 5 mL, or a volume greater than about 10 mL, or a volume greater than about 15 mL, or a volume greater than about 30 mL, or a volume greater than about 50 mL, or a volume greater than about 70 mL, or a volume in a range of from about 4 mL to about 200 mL, such as a volume in a range of from about 4 mL to about 50 mL, a volume in a range of from about 4 mL to about 30 mL, or a volume in a range of from about 5 mL to about 100 mL, such as a volume in a range of from about 5 mL to about 50 mL, or a volume in a range of from about 5 mL to about 30 mL, or a volume in a range of from about 6 mL to about 100 mL, or a volume in a range of from about 6 mL to about 50 mL, or a volume in a range of from about 6 mL to about 25 mL, or a volume in a range of from about 10 mL to about 100 mL, or a volume in a range of from about 10 mL to about 50 mL, or a volume in a range of from about 10 mL to about 25 mL, or a volume in a range of from about 10 mL to about 20 mL. Such terms also include any kind of living material having such a volume to be cryopreserved, such as cellular materials, tissues and organs (including, for example, large blood vessels (e.g., a pulmonary artery), or cartilage). In some embodiments, the tissues and organs having such a volume may be mammalian organs (such as human organs), mammalian cells and mammalian tissues (such as human tissues).

The cryopreservation methodology described herein uses a cryoprotectant solution that includes Fe nanoparticles to aid in warming the preserved, vitrified, sample. A sample to be preserved may be submerged in or perfused with a cryoprotectant formulation, such as VS83 prior to rapid cooling to a vitreous (a non-crystalline or amorphous) state. In embodiments, external radio frequency fields can be applied for controlled interaction with the nanoparticles (such as Fe mNPs), leading to the generation of heat at nanoparticle sites dispersed throughout the biomaterial. This generation of heat at dispersed sites results in quick and uniform thawing of cryopreserved sample. The use of radio frequency fields in conjunction with magnetic nanoparticles allows controlled heating rates to be in the range of from about 0.5° C./second to about 20.0° C./second, such as during warming from about −135° C. to about −30° C., or in the range of from about 0.6° C./second to about 10.0° C./second, such as during warming from about −135° C. to about −30° C., or in the range of from about 0.8° C./second to about 5.0° C./second, such as during warming from about −135° C. to about −30° C., or in the range of from about 1.0° C./second to about 2.5° C./second, such as during warming from about −135° C. to about −30° C. These rates of warming avoids overheating, ice formation and loss of chondrocyte viability.

In embodiments, this disclosure is directed to a new approach for uniformly heating vitrified samples that have been preserved in a high concentration CPA formulation, such as VS83, through the use of radio frequency (e.g. 234 kHz) excited Fe nanoparticles. This technique can suitably control the heating rates more uniformly over conventional boundary heating. Radio frequency thawing of samples perfused with or incubated in high concentrations of cryoprotective agents that include the nanoparticles of the present disclosure decreases the risks of devitrification and subsequent ice formation. While existing methods include the use of nanoparticles (such as magnetic nanoparticles) in lower concentration cryoprotective solutions, various challenges with respect to toxicity (at high cryoprotectant concentrations) and uniformity of heating throughout a sample of larger dimension have limited the application of the existing methods.

In some embodiments, the mNPs of the present disclosure can include a combination of nanoparticles (e.g., a superparamagnetic nanoparticle and a ferromagnetic nanoparticle) to heat in two different cryoprotective agent solutions (where at least one of the solutions is VS83) under a range of applied fields that can scaled to larger systems.

Cryopreservation requires that the biomaterial undergo controlled rate freezing procedures that can damage and potentially destroy cells in suspension, monolayers, or within a tissue or organ. At the cellular level, this injury can involve dehydration and/or intracellular ice formation. These factors are oppositely dependent on the cooling rate: slow cooling can lead to dehydration, fast cooling can produce intracellular ice formation. When taken to extremes, both of these factors are known to reduce cell viability in suspension, but in the methodology of the present disclosure by adding a high molarity of cryoprotective agent, such as that of VS83, the best chondrocyte viability and metabolic activity was surprisingly observed (i.e., versus VS55 and VS70).

For example, in the methods of the present disclosure, the metabolic activity of the nano-warmed tissue (i.e., the cellular material being preserved) may be fully recovered to control values within 24 hours of being rewarmed (e.g., after being stored/vitrified), 36 hours of being rewarmed, or within 48 hours of being rewarmed, or within 96 hours of being rewarmed. The control values being assessed/set with a fresh tissue (i.e., being of an identical tissue type to that of the cellular material exposed to the high concentration cryoprotectant formulation) in a suitable growth media for that particular tissue being preserved. The restored metabolic activity then be maintained (such as for a period of hours, days, or at least 3 days, or a period of at least 5 days, or a period of at least 7 days) until the cryopreserved cellular materials preserved by the methods of the present disclosure is put to the intended use thereof, including, for example, research or therapeutic uses (e.g., transplantation).

Vitrification relies on loading a high enough concentration of cryoprotective agent and cooling rapidly enough to reach below the glass transition temperature (T_{g}) while minimizing or avoiding nucleation of ice (Tₕ). Once below the glass transition temperature, the sample being cryopreserved is stable and can be stored. To thaw, one faces a similar challenge in reverse, which is to pass through the devitrification temperature (T_{d}) without allowing crystals to grow. Avoiding ice growth as one moves through the devitrification and liquidus temperatures (T_{d} and Tₘ) can be achieved by increasing both cryoprotective agent concentration and/or thawing rates. The methodology of the instant disclosure improves upon how to successfully thaw the cryopreserved sample from the vitrified state achieved with a high concentration of cryoprotective agent(s).

In this regard, this disclosure describes a new approach for preserving and warming vitrified samples through the use of excited mNPs. The addition of the nanoparticles of the present disclosure in a well-known cryoprotectant (VS83) has negligible effects on its cooling/warming behavior. “VS83” is an optimized cryoprotectant cocktail that has demonstrated successful vitrification of tissue matrices. VS83 solution is composed of 4.65 mol/L dimethyl sulfoxide, 4.65 mol/L formamide and 3.31 mol/L propylene glycol in 1× EuroCollins solution) as described in Brockbank et al., Vitrification of heart valve tissues. Methods Mol Biol 2015; 1257:399-421. The disclosure of which is hereby incorporated by reference in its entirety.

The studies described herein were conducted with commercially available EMG308 from Ferrotec composed of 10 nm-diameter nanoparticles in aqueous suspension. The stock solution was diluted in the VS83 cryoprotectant solution to provide a concentration of 2 mg/ml Fe mNP. The cryoprotectant-mNP mixtures were formulated to account for the volume of aqueous mNP solution, such that the final mixtures were 12.6 M VS83 (4.65M DMSO, 4.65M formamide, and 3.31M 1,2-propanediol in Euro-Collins).

The VS83 solution has a glass transition via differential scanning calorimetry (DSC) of −118.69 C (Brockbank, K. G. M., Wright, G. J., Yao, H., Greene, E. D., Chen, Z. Z., Schenke-Layland, K. (2011) Allogeneic heart valve preservation—Allogeneic Heart Valve Storage Above the Glass Transition at —80° C. The Annals of Thoracic Surgery, 91:1829-1835.). Pure VS83 does not have either a Critical Cooling Rate or Critical Warming Rate, ice will not form in it. However, as some tissues (particularly large tissues) may not be fully cryoprotectant permeated rapid cooling and warming rates are required.

In embodiments, the preserved sample will contain a sufficiently uniform distribution of nanoparticles. Alternatively, in some embodiments, the nanoparticle distribution may not be perfectly uniform. The use of nanoparticles for rewarming a cryopreserved sample that has been cryopreserved in a high concentration cryoprotectant formulation, such as VS83, can provide more uniform heating rates that can, in turn, reduce devitrification and/or other detrimental effects on the cryopreserved sample. Further, the use of the disclosed nanoparticles to rewarm a cryopreserved sample facilitate cryopreservation of larger systems with higher molarity cryoprotectants.

In embodiments, this disclosure describes a cryoprotective composition that includes a cryoprotective agent/formulation (e.g., at a high concentration, such as VS83) and nanoparticles (such as mNPs) effective for thawing a cryopreserved sample that includes tissue/cellular material with minimal damage to the tissue/cellular material. The cryoprotective agent/formulation can include any material suitable for the cryopreservation of biomaterials. Exemplary suitable cryoprotective agents include, for example, combinations of alcohols, sugars, polymers and ice blocking molecules that alter the phase diagram of water and allow a glass to be formed more easily (and/or at higher temperatures) while also reducing the likelihood of ice nucleation and growth during cooling or thawing. In most cases, cryopreservative agents are not used alone, but in cocktails.

The methods of the present disclosure comprise bringing a cellular material (such as, for example, large blood vessels (e.g., a pulmonary artery), or cartilage) into contact with a cryoprotectant solution containing an effective amount of mNPs, such as 2 mg/mL Fe mNPs. In some embodiments, this may comprise incubating a large volume cellular material (such as, for example, large blood vessels (e.g., a pulmonary artery), or cartilage) in such cryoprotectant formulation/solution along with at least one sugar, such as a disaccharide (e.g., trehalose and/or sucrose). In embodiments, the at least one sugar, such as a disaccharide (e.g., trehalose and/or sucrose), may be present in the cryoprotectant formulation/solution in an amount effective to provide an environment more conducive to survival of the cells of the large volume cellular material (such as, for example, large blood vessels (e.g., a pulmonary artery), or cartilage) during cooling and rewarming.

In some embodiments, the cellular cryopreserved material (such as, for example, large blood vessels (e.g., a pulmonary artery), or cartilage) preserved by the methods of the present disclosure retains at least 50% of the intended function, such as at least 60% of the intended function, such as at least 70% of the intended function, such as at least 80% of the intended function, such as at least 90% of the intended function, such as at least 95% of the intended function, such as 100% of the intended function. For example, along with preserving the viability of the cells in tissues and organs, it may be important to also maintain/preserve the physiological function of the cell/tissue/organ, e.g. for a heart the pumping function, and/or the ability of a tissue/cell(s) (e.g., those to be transplanted) to integrate with surrounding tissue/cell(s).

In embodiments, the solution, such as a known solution, like VS83, well suited for organ storage of cells, tissues and organs, may contain any effective amount of mNPs that is effective to provide an environment more conducive to survival of the cells of the large volume cellular material during the preservation protocol.

In some embodiments, in the methods of the present disclosure a medium (the terms “medium” and “solution” are used interchangeably) containing the mNPs in combination with other cryoprotectants may be combined with cellular materials, such as tissues and organs to prepare a cryopreservation composition. The medium (which may be an aqueous medium) can contain any suitable concentration of the mNPs in combination with cryoprotectants for these purposes.

In some embodiments, at least one type of mNP in combination with a high concentration of cryoprotectants, such as that of VS83, is used in an amount in the methods of the present disclosure such that it results in an improved viability (post-cryopreservation) of the living cellular material/sample selected from the group consisting of organs, cells and tissues, such as mammalian organs, mammalian cells, and mammalian tissues (including those which may be subsequently transplanted). The phrases, “improved cell viability” or “improved viability,” refer, for example, to a cell viability (%) of at least 60%, such as 80% or more. The improved cell viability (%) may be 50% or more, 60% or more, 70% or more, 73% or more, 75% or more, 77% or more, 80% or more, 83% or more, 85% or more, 87% or more, 90% or more, 93% or more, 95% or more, 97% or more, 98% or more, or 99% or more.

In embodiments, the formulation/solution/medium comprising the mNPs may be contacted with the sample to be preserved for any desired duration, such as until a desired dosage (such as an effective dosage) of the mNPs is present on/in the cells or tissues to afford an improved viability (post-cryopreservation), and/or to prevent/protect against tissue damage upon nanowarming.

In some embodiments, the cells to be cryopreserved may also be in contact with a freezing-compatible pH buffer comprised of, for example, at least a basic salt solution, an energy source (for example, glucose), and a buffer capable of maintaining a neutral pH at cooled temperatures. Well known such materials include, for example, Dulbecco's Modified Eagle Medium (DMEM). This material may also be included as part of the cryopreservation composition. See, e.g., Campbell et al., “Cryopreservation of Adherent Smooth Muscle and Endothelial Cells with Disaccharides,” In: Katkov I. (ed.) Current Frontiers in Cryopreservation. Croatia: In Tech (2012); and Campbell et al., “Development of Pancreas Storage Solutions: Initial Screening of Cytoprotective Supplements for β-cell Survival and Metabolic Status after Hypothermic Storage,” Biopreservation and Biobanking 11(1): 12-18 (2013). The disclosures of which are each hereby incorporated by reference in their entireties.

In some embodiments, the cryoprotectant compounds (in total, including the sugars and any other cryoprotectant) may be present in the cryopreservation composition in an amount of from, for example, about 8.5 M to about 15 M, about 9.0 to about 13 M, about 10 to about 13 M, about 10.5 to about 12.8 M, about 11.5 to about 12.8 M, about 12.2 to about 12.75 M. or about 12.50 to about 12.75 M. In some embodiments, the cryoprotectant compounds (in total, including the sugars and any other cryoprotectant) may be present in the cryopreservation composition in an amount of about 12.6 M, or about 12.4 M, or about 12.2 M, or about 12.0 M, or about 12.8 M, or about 13.0 M.

In some embodiments, the cellular material to be preserved may be brought into contact with a further cryoprotectant (beyond, for example, VS83) and/or the mNP-containing solution/medium/formulation/composition of the methods of the present disclosure.

Suitable further cryoprotectants may include, for example, acetamide, agarose, alginate, alanine, albumin, ammonium acetate, anti-freeze proteins, butanediols (such as 2,3-butanediol), chondroitin sulfate, chloroform, choline, cyclohexanediols, cyclohexanediones, cyclohexanetriols, dextrans, diethylene glycol, dimethyl acetamide, dimethyl formamide (such as n-dimethyl formamide), dimethyl sulfoxide, erythritol, ethanol, ethylene glycol, ethylene glycol monomethyl ether, formamide, glucose, glycerol, glycerophosphate, glyceryl monoacetate, glycine, glycoproteins, hydroxyethyl starch, inositol, lactose, magnesium chloride, magnesium sulfate, maltose, mannitol, mannose, methanol, methoxy propanediol, methyl acetamide, methyl formamide, methyl ureas, methyl glucose, methyl glycerol, phenol, pluronic polyols, polyethylene glycol, polyvinylpyrrolidone, proline, propanediols (such as 1,2-propanediol and 1,3-propanediol), pyridine N-oxide, raffinose, ribose, serine, sodium bromide, sodium chloride, sodium iodide, sodium nitrate, sodium nitrite, sodium sulfate, sorbitol, triethylene glycol, trimethylamine acetate, urea, valine and xylose. Other cryoprotectants that may be used in the present disclosure are described in U.S. Pat. No. 6,395,467 to Fahy et al.; U.S. Pat. No. 6,274,303 to Wowk et al.; U.S. Pat. No. 6,194,137 to Khirabadi et al.; U.S. Pat. No. 6,187,529 to Fahy et al.; U.S. Pat. No. 5,962,214 to Fahy et al.; U.S. Pat. No. 5,955,448 to Calaco et al.; U.S. Pat. No. 5,629,145 to Meryman; and/or WO 02/32225 A2, which corresponds to U.S. patent application Ser. No. 09/691,197 to Khirabadi et al., the disclosures of which are each hereby incorporated by reference in their entireties.

The cryopreservation composition also may include (or be based on) a solution well suited for storage of cells, tissues and organs. The solution may include well known pH buffers. In some embodiments, the solution may be, for example, the EuroCollins Solution, which is composed of dextrose, potassium phosphate monobasic and dibasic, sodium bicarbonate, and potassium chloride, described in Taylor et al., “Comparison of Unisol with Euro-Collins Solution as a Vehicle Solution for Cryoprotectants,” Transplantation Proceedings 33: 677-679 (2001). The disclosure of which is hereby incorporated by reference in its entirety. Alternatively the cryoprotectant solution may be formulated in an alternative solution, such as Unisol.

Still further, the cryopreservation composition for use in the methods of the present disclosure may also include an anti-freeze glycolipid (AFGL), anti-freeze protein/peptide (AFP), “thermal hysteresis” proteins, (THPs) or ice recrystallization inhibitors (IRIs). Such materials may be present in the cryopreservation composition in an amount of from, for example, about 0.001 to about 1 mg/mL, about 0.05 to about 0.5 mg/mL, or about 0.1 to about 0.75 mg/mL of composition.

In some embodiments, at least one sugar, such as a disaccharide (e.g., trehalose and/or sucrose), may act as a replacement for a cryoprotectant, such as, for example, DMSO, or as a supplement to such other cryoprotectants to reduce the concentration thereof, such as to non-toxic concentrations (depending on the tissue at issue), at which the cryoprotectant achieves the same or better protective effects with regard to preserving as much functionality of the cryopreserved material/sample during the cryopreservation procedure. For example, in some embodiments, the at least one sugar, such as a disaccharide (e.g., trehalose and/or sucrose), may act as a replacement for a cryoprotectant, such as, for example, DMSO, in a solution known as “VS83”, which is an optimized cryoprotectant cocktail that has demonstrated successful vitrification of many biological systems. In this regard, the at least one sugar, such as a disaccharide (e.g., trehalose and/or sucrose), may act as a replacement for the cryoprotectant in the VS83 solution, to reduce the concentration thereof, or as a supplement to the other cryoprotectants in VS83 at which the cryoprotectant achieves the same or better protective effects with regard to preserving as much functionality of the cryopreserved material/sample during the cryopreservation procedure.

Still further, the cryopreservation composition for use in the methods of the present disclosure may also include one or more additional supplements and/or additives at suitable concentrations to accomplish the intended function and/or mechanism of action. In some embodiments, the effective concentration range for the antioxidant may be in the range of from about 0.5 μM to about 1000 μM, such as about 5 μM to about 500 μM, or 50 μM to about 200 μM. In some embodiments, the effective concentration range for the apoptosis inhibitor may be in the range of from about 0.1 μM to about 100 μM, such as about 1 μM to about 50 μM, or 5 μM to about 20 μM.

In some embodiments, the exemplary supplements and/or additives that may be added to the cryopreservation composition of the instant disclosure and/or used in the methodology of the instant disclosure include one or more of those that are listed below in Table I.

TABLE 1

| Supplements/additives | Mechanisms of Action |
|---|---|
| Trolox and/or α-tocopherol | Antioxidants |
| (vitamin E) | Trolox is an analogue of α-tocopherol |
| acetylcysteine | (vitamin E) |
| Superoxide dismutase | |
| GSH-MEE | |
| Glutathione | |
| Q-VD-OPh | Broad spectrum apoptosis pathway |
| Z-VAD-FMK | inhibitors |
| Ivachtin | Specific apoptosis pathway inhibitors |
| Pifithrin-α | |
| Bax inhibitor P5 | |
| 3-OMG | Metabolic inhibitor substituting for |
| | glucose |
| Hydrogen sulphide | Metabolic inhibitor by inhibition of |
| | cytochrome C |

In some embodiments, the effective concentration range for the Trolox and/or α-tocopherol may be in the range of from about 0.5 μM to about 10 mM, such as about 5 μM to about 500 μM, or about 50 μM to about 200 μM. In some embodiments, the effective concentration range for the acetylcysteine may be in the range of from about 0.1 μM to about 50 mM, such as about 1 mM to about 40 mM, or about 10 mM to about 30 mM. In some embodiments, the effective concentration range for the superoxide dismutase may be in the range of from about 1 mg/mL to about 400 mg/mL, such as about 10 mg/mL to about 300 mg/mL, or a bout 100 mg/mL to about 250 mg/mL. In some embodiments, the effective concentration range for the GSH-MEE may be in the range of from about 500 μM to about 20 mM, such as about 1000 μM to about 12 mM, or about 2 mM to about 10 mM. In some embodiments, the effective concentration range for the Glutathione may be in the range of from about 100 μM to about 11 mM, such as about 500 μM to about 6 mM, or about 2 mM to about 4 mM. In some embodiments, the effective concentration range for the Q-VD-OPh may be in the range of from about 0.5 μM to about 50 μM, such as about 5 μM to about 40 μM, or about 20 μM to about 30 μM. In some embodiments, the effective concentration range for the Z-VAD-FMK may be in the range of from about 1 μM to about 100 μM, such as about 5 μM to about 80 μM, or about 40 μM to about 60 μM. In some embodiments, the effective concentration range for the Ivachtin may be in the range of from about 0.5 nM to about 50 nM, such as about 5 nM to about 40 nM, or about 20 nM to about 25 nM. In some embodiments, the effective concentration range for the Pifithrin-α may be in the range of from about 0.1 mM to about 60 mM, such as about 1 mM to about 40 mM, or about 10 mM to about 30 mM. In some embodiments, the effective concentration range for the Bax inhibitor P5 may be in the range of from about 0.5 μM to about 0.5 mM, such as about 5 μM to about 400 μM, or about 50 μM to about 200 μM. In some embodiments, the effective concentration range for the 3-OMG may be in the range of from about 0.1 mM to about 400 mM, such as about 10 mM to about 300 mM, or about 50 mM to about 200 mM. In some embodiments, the effective concentration range for the hydrogen sulphide may be in the range of from about 0.1 ppm to about 60 ppm, such as about 1 ppm to about 40 ppm, or about 10 ppm to about 30 ppm.

The cells in the cellular materials that may be used in the methods of the present disclosure can be any suitable cell composition. In some embodiments, the cells can be skin cells, keratinocytes, skeletal muscle cells, cardiac muscle cells, lung cells, mesentery cells, adipose cells, stem cells, hepatocytes, epithelial cells, Kupffer cells, fibroblasts, neurons, cardio myocytes, myocytes, chondrocytes, pancreatic acinar cells, islets of Langerhans, osteocytes, myoblasts, satellite cells, endothelial cells, adipocytes, preadipocytes, biliary epithelial cells, and progenitor cells or combinations of any of these cell types.

In some embodiments, the cells/tissue (such as, for example, large blood vessels (e.g., a pulmonary artery), or cartilage) used in the methods of the present disclosure may be from any suitable species of animal, for example a mammal, such as a human, canine (e.g. dog), feline (e.g. cat), equine (e.g. horse), porcine, ovine, caprine, or bovine mammal.

The formulation/composition used to prepare the cryopreservation solution can be combined with the mNPs in a variety of ways. In some embodiments, a cellular material (such as, for example, large blood vessels (e.g., a pulmonary artery), or cartilage) can be combined with an aqueous liquid medium, such as an aqueous solution, containing the mNPs. For example, a gradual combination, optionally with gentle agitation, can be conducted.

Once the cryopreservation composition has been prepared (and the mNPs associated with the cellular material to be preserved), the cooling for ice-free vitrified cryopreservation may be conducted in any manner, and may use any additional materials to those described above. Protocols for preserving cellular material are described in the following patents and publications: U.S. Pat. No. 6,395,467 to Fahy et al.; U.S. Pat. No. 6,274,303 to Wowk et al.; U.S. Pat. No. 6,194,137 to Khirabadi et al.; U.S. Pat. No. 6,187,529 to Fahy et al.; U.S. Pat. No. 6,127,177 to Toner et al.; U.S. Pat. No. 5,962,214 to Fahy et al.; U.S. Pat. No. 5,955,448 to Calaco et al.; U.S. Pat. No. 5,827,741 to Beattie et al.; U.S. Pat. No. 5,648,206 to Goodrich et al.; U.S. Pat. No. 5,629,145 to Meryman; U.S. Pat. No. 5,242,792 to Rudolph et al.; and WO 02/32225 A2, which corresponds to U.S. patent application Ser. No. 09/691,197 to Khirabadi et al., the disclosure of which are each hereby incorporated in their entirety by reference.

The cryopreservation portion of the preservation protocol typically involves cooling cells/tissue (such as, for example, large blood vessels (e.g., a pulmonary artery), or cartilage) to temperatures well below the freezing point of water, e.g., to about −80° C. or lower, more typically to about −130° C. or lower. Any method of cryopreservation known to practitioners in the art may be used. For example, the cooling protocol for cryopreservation may be any suitable type in which the cryopreservation temperature may be lower (i.e., colder) than about −20° C., such as about −80° C. or lower (i.e., colder), or about −135° C. or lower (i.e., colder). In some embodiments, the cryopreservation temperature may be in a range of from about −20° C. to about −196° C., or about −120 to about −196° C., or about −130° C. to about −196° C., or about −140° C. to about −190° C., or about −150° C. to about −190° C., or about −150° C. to about −180° C., or about −30 to about −175° C., or about −80° C. to about −160° C., or about −85° C. to about −150° C., or about −95° C. to about −135° C., or about −80° C. to about −180° C., or about −90° C. to about −196° C., or about −100° C. to about −196° C.

In some embodiments, the preservation protocol may include continuous controlled rate cooling from the point of temperature control initiation (+4 to −30° C.) to −80° C. or any of the above disclosed cooling temperatures, with the rate of cooling depending on the characteristics of the cells/tissues being cryopreserved. For example, the cooling protocol for cryopreservation may be at any suitable rate, such as a rate (and/or average cooling rate, for example from the initial temperature of the sample to the cryopreservation temperature) may be greater than about −0.1° C. per minute, or greater than about −4.0° C. per minute, or greater than about −6.0° C. per minute, or greater than about −8.0° C. per minute, or greater than about −10.0° C. per minute, or greater than about −14.0° C. per minute, or greater than about −25.0° C. per minute, or greater than 50° C. per minute. The cooling rate (and/or average cooling rate), such as, for example, for continuous rate cooling (or other types of cooling), may be, for example, from about −0.1° C. to about −10° C. per minute or about −1° C. to about −2° C. per minute. The cooling rate may be about −0.1 to about −9° C. per minute, about −0.1 to about −8° C. per minute, about −0.1 to about −7° C. per minute, about −0.1 to about −6° C. per minute, about −0.1 to about −5° C. per minute, about −0.1 to about −4° C. per minute, about −0.1 to about −3° C. per minute, about −0.1 to about −2° C. per minute, about 0.1 to about −1° C. per minute, about 0.1 to about −0.5° C. per minute, about −1 to about −2° C. per minute, about −1 to about −3° C. per minute, about −1 to about −4° C. per minute, about −1 to about −5° C. per minute, about −1 to about −6° C. per minute, about −1 to about −7° C. per minute, about −1 to about −8° C. per minute, about −1 to about −9° C. per minute, about −1 to about −10° C. per minute, about −2 to about −3° C. per minute, about −2 to about −5° C. per minute, about −2 to about −7° C. per minute, about −2 to about −8° C. per minute, about −2 to about −20° C. per minute, about −4 to about −10° C. per minute, about −4° per minute to about −8° C. per minute, about −4 to about −6° C. per minute, about −6 to about −10° C. per minute, about −6 to about −9° C. per minute, about −6 to about −8° C. per minute, about −6 to about −7° C. per minute, about −7 to about −10° C. per minute, about −7 to about −9° C. per minute, about −7 to about −8° C. per minute, about −8 to about −9° C. per minute, about −9 to about −10° C. per minute, about −7 to about −30° C. per minute, about −10 to about −25° C. per minute, about −15 to about −25° C. per minute, about −20 to about −25° C. per minute, or about −20 to about −30° C. per minute. The preservation protocol may also be independent of cooling rate in some embodiments.

Once the samples to be preserved (e.g., cellular materials and/or tissues) are cooled to about −40° C. to −80° C. or lower by continuous cooling, they may be transferred to liquid nitrogen or the vapor phase of liquid nitrogen for further cooling to the cryopreservation temperature, which is typically below the glass transition temperature of the freezing solution. The samples to be preserved (e.g., cellular materials and/or tissues) may be cooled to about −40° C. to about −75° C., about −45° C. to about −70° C., about −50° C. to about −60° C., about −55° C. to about −60° C., about −70° C. to about −80° C., about −75° C. to about −80° C., about −40° C. to about −45° C., about −40° C. to about −50° C., about −40° C. to about −60° C., about −50° C. to about −70° C., or about −50° C. to about −80° C. before further cooling to the cryopreservation temperature. Alternatively the samples may be cooled to −120° C. before further cooling to the desired cryopreservation temperature. However, it is anticipated that the outcome is independent of cooling rate because ice formation will not occur. The limiting factor for retention of cell viability will be the duration of cryoprotectant exposure at temperatures close to zero centigrade, the lower the temperature the less the risk of cytotoxic effects until storage temperatures are achieved at which no deterioration of viability is anticipated.

The cryoprotectant formulations supplemented with mNPs and/or sugars (such as trehalose and or sucrose) have a reduced propensity for ice nucleation during nanowarming and/or exposure to temperatures above the glass transition temperature. Thus, cellular materials in these formulations will tolerate short term exposure to temperatures such as −80° C., for minutes or hours. The precise duration depending upon the cryoprotectant mNP formulation. The duration tolerated at each temperature will depend upon the relative cytotoxicity of the cryoprotectant formulation employed at that temperature. Furthermore, it is anticipated that these cryoprotectant formulations can be used for storage of tissues, where cell viability is not desired (some heart valves, skin, tendons and peripheral nerve grafts for example), at temperatures ranging from liquid nitrogen to physiological temperatures below the denaturation temperature range of collagen (approximately 60° C.).

Some embodiments, the methods of the instant disclosure may comprise a stepwise cooling process, in which the temperature of the tissue is decreased to a first temperature in a solution containing cryoprotectant at a first temperature between the glass −120° C. and −20° C., then is further decreased to a second temperature in the same solution containing cryoprotectant at temperature between the glass transition temperature of the first solution and −20° C., and this process may be repeated with a third, fourth, fifth, sixth, seventh, etc., solution until the desired temperature is achieved. The mNPs should be introduced/distributed into the sample/material being preserved in the first step just before initiation of cooling.

In embodiments, the glass transition temperature of the first solution (such as a cryoprotectant formulation including mNPs) may be in set at any desired level, such as, for example, in a range of from about −100° C. to about −140° C., such as about −110° C. to about −130° C., or −115° C. to about −130° C.

After being immersed in an initial solution, the sample to be preserved (such as a cellular material or tissue) may be immersed in a solution containing cryoprotectant and mNPs. The final cryoprotectant and mNP concentration may be reached in a stepwise cooling process. Addition of the cryoprotectant solution to the cellular material is a step wise process in which cryoprotectants are added 4 or more steps, alternatively a continuous gradient may be employed. The final cryoprotectant steps may be performed at subzero temperatures, −25 to −1° C. in alcohol baths. Furthermore, the mNPs are added in the last cryoprotectant addition step.

In embodiments, the sample to be preserved (such as a cellular material or tissue) may remain free from ice and/or free from ice-induced damage during the preservation protocol (e.g., the cooling protocol, storage, and warming protocol). For example, after completion of the cooling process, the sample to be preserved (such as a cellular material or tissue) may remain free from ice and/or free from ice-induced damage during the storage step/phase for a long period of time, such as a period of at least 3 days, or a period of at least 5 days, or a period of at least 7 days, or a period of at least 8 days, months or years.

In some embodiments, upon initiation of the cooling process, the sample to be preserved (such as a cellular material or tissue) may remain free from ice and/or free from ice-induced damage during the entire preservation protocol (i.e., during the cooling protocol, storage, and warming protocol), where the entire preservation protocol (e.g., the cooling protocol, storage step/phase, and warming protocol) has a duration in a range of from at least 3 days to up to about 3 months, or a duration in a range in a range of from at least 5 days up to about 2 months, or a duration in a range in a range of from at least 7 days up to about 1 month, or a duration in a range in a range of from at least 8 days up to about 21 days, or a duration in a range in a range of from at least 8 days up to about 14 days.

The nanoparticles (mNPs) may be any mNPs excitable by a radio frequency (i.e., RF susceptible nanoparticles), including, without limitation, alternating magnetic frequencies, or rotating magnetic frequencies, and as described below. The nanoparticles can include one or more elements such as, for example, iron, and compounds containing atoms that generate heat when placed in a magnetic field.

As used herein, a particle may be considered a mNP if it possesses a maximum diameter of no more than one micrometer (μm), but may be incorporated as part of a structure—e.g., an aggregate—with characteristic dimensions larger than one micrometer. The dimensions provided herein refer to dimensions of the nanoparticle, not the dimension of the larger structure. Thus, the maximum diameter of a nanoparticle can be, for example, no more than 800 nanometers (nm), no more than 700 nm, no more than 600 nm, no more than 500 nm, no more than 450 nm, no more than 400 nm, no more than 350 nm, no more than 300 nm, no more than 250 nm, no more than 200 nm, no more than 150 nm, no more than 100 nm, no more than 90 nm, no more than 80 nm, no more than 70 nm, no more than 60 nm, no more than 50 nm, no more than 40 nm, no more than 30 nm, no more than 25 nm, no more than 20 nm, no more than 15 nm, no more than 10 nm, or no more than 1 nm. A particle can be considered a mNP if it possesses a minimum diameter of at least 1 nm such as, for example, at least 2 nm, at least 3 nm, at least 4 nm, at least 5 nm, at least 6 nm, at least 7 nm, at least 8 nm, at least 9 nm, at least 10 nm, at least 25 nm, at least 50 nm, at least 100 nm, at least 250 nm, or at least 500 nm. In some embodiments, the size of the mNPs may include a range with endpoints defined by any maximum diameter listed above and any minimum diameter listed above that is smaller than the maximum diameter.

In some embodiments, the mNPs can include superparamagnetic nanoparticles. In other embodiments, the mNPs can include ferromagnetic nanoparticles. The mNPs can have any suitable shape such as, for example, spherical, cubical, pyramidal, etc. In some embodiments, the mNPs can include a combination of any two or more types of nanoparticles. In some embodiments, the mNPs can aggregate. In such embodiments, the mNPs can interact with one another. In some of these embodiments, one can tune the aggregation of mNPs to enhance or diminish the heating rate in a particular application, as desired.

The mNPs can be present in the cryoprotective formulation, such as VS83, in an amount sufficient to provide minimum at least 0.5 mg of atoms that can be magnetically excited to generate heat per milliliter of the vitrified tissue such as, for example, at least 1.0 mg/ml, at least 1.5 mg/ml, at least 3.0 mg/ml, at least 4.0 mg/ml, at least 5.0 mg/ml, at least 6.0 mg/ml, at least 7.0 mg/ml, at least 8.0 mg/ml, at least 9.0 mg/ml, at least 10 mg/ml, at least 11 mg/ml, at least 12 mg/ml, at least 13 mg/ml, at least 14 mg/ml, at least 15 mg/ml, at least 20 mg/ml, at least 25 mg/ml, or at least 50 mg/ml. In some embodiments, the mNPs can be present in the cryoprotective formulation, such as VS83, in an amount sufficient to provide a maximum of no more than 100 mg/ml, no more than 75 mg/ml, no more than 50 mg/ml, no more than 25 mg/ml, no more than 20 mg/ml, no more than 15 mg/ml, no more than 10 mg/ml, no more than 9 mg/ml, no more than 5 mg/ml, no more than 3 mg/ml, no more than 2.5 mg/ml, no more than 2 mg/ml, 0.2 mg/mL. In some embodiments, the amount of the magnetic nanoparticles in the cryoprotective composition may be characterized as a range having endpoints defined by any minimum amount listed above and any maximum amount listed above that is smaller than the maximum amount.

The cryoprotective composition and mNPs can be used in a method for thawing a cryopreserved sample that includes tissue/cellular material with minimal damage to the tissue/cellular material. The variables for the warming protocol (such as Amps, kHz and time) may be appropriately to be effective for the tissues (and size thereof) being warmed, the warming rate selected, the identity of the mNP, and the mNP concentration/distribution.

For example, in some embodiments, the settings for an inductive heating system may be set in a range of from 10 to 800 Amps/10 to 1000 kHz/for 20 to 300 seconds, or may be set in a range of from 100 to 700 Amps/50 to 700 kHz/for 40 to 200 seconds, or may be set in a range of from 300 to 600 Amps/150 to 300 kHz/for 50 to 120 seconds, or may be set in a range of from 450 to 550 Amps/150 to 300 kHz/for 60 to 100 seconds, or may be set in a range of from 475 to 525 Amps/200 to 250 kHz for 70 to 90 seconds, or may be set in a range of from 300 to 600 Amps/150 to 300 kHz for 50 to 120 seconds, or may be set to about 500 Amps and about 234 kHz for about 80 seconds.

In some embodiments, the radio frequency field may range from about 210 kHz to about 250 Hz. In another particular example, the radio frequency field may range from 230 kHz to about 240 kHz, such as about 234 kHz.

In some embodiments, the electromagnetic energy can include a radio frequency field, alternating magnetic field, or rotating magnetic field. In such embodiments, the electromagnetic energy can exhibit a minimum frequency of no more than 1 MHz such as, for example, no more than 750 Hz, no more than 500 Hz, no more than 375 Hz, no more than 300 Hz, no more than 250 Hz, no more than 225 Hz, no more than 200 Hz, no more than 175 Hz, no more than 150 Hz, no more than 125 Hz, no more than 100 Hz, no more than 75 Hz, or no more than 50 Hz. In some embodiments, the radio frequency field can exhibit a maximum frequency of at least 1 Hz such as, for example, at least 5 Hz, at least 10 Hz, at least 25 Hz, at least 50 Hz, at least 75 Hz, at least 100 Hz, at least 125 Hz, at least 150 Hz, at least 175 Hz, at least 200 Hz, at least 225 Hz, or at least 250 Hz. In some embodiments, the radio frequency field may be characterized by a range of frequencies having as endpoints any minimum frequency listed above and any maximum frequency listed above that is greater than the minimum frequency and may be time-dependent. In some embodiments, for example, the radio frequency field may range from about 175 Hz to about 375 Hz. In another particular example, the radio frequency field may range from 100 Hz to about 500 Hz.

In some embodiments, the warming protocol (e.g., involving the mNPs) may involve the application of 10 to 800 Amps, the application of 100 to 700 Amps, the application of 300 to 600 Amps, or the application of 450 to 550 Amps, or the application of from 475 to 525 Amps, or the application of 300 to 600 Amps, the application of about 500 Amps, such as, for example during at least a portion of the warming protocol (e.g., involving the mNPs), such as, for example, from below the temperature of −135° C. to −30° C., or during the entire warming protocol (e.g., involving the mNPs).

In some embodiments, the warming protocol (e.g., involving the mNPs) may involve the application of at least 1 Amp/min such as, for example, at least 5 Amp/min, at least 10 kA/m, at least 20 kA/m, at least 30 kA/m, at least 50 kA/m, at least 75 kA/m, or at least 100 kA/m. In some embodiments, the radio frequency filed may have a maximum strength of no more than 200 kA/m such as, for example, no more than 150 kA/m, no more than 100 kA/m, no more than 80 kA/m, no more than 50 kA/m, or no more than 25 kA/m. In some embodiments, the strength of the radio frequency field may be characterized as a range having as endpoints any minimum strength listed above and any maximum strength listed above that is greater than the minimum strength and may be time-dependent. In some embodiments, the radio frequency field may have a strength of from about 10 kA/m to about 100 kA/m. In one particular embodiment, the radio frequency filed can have a strength of 24 kA/m.

In some embodiments, the radio frequency field may have a minimum strength of at least 1 kA/m such as, for example, at least 5 kA/m, at least 10 kA/m, at least 20 kA/m, at least 30 kA/m, at least 50 kA/m, at least 75 kA/m, or at least 100 kA/m. In some embodiments, the radio frequency filed may have a maximum strength of no more than 200 kA/m such as, for example, no more than 150 kA/m, no more than 100 kA/m, no more than 80 kA/m, no more than 50 kA/m, or no more than 25 kA/m. In some embodiments, the strength of the radio frequency field may be characterized as a range having as endpoints any minimum strength listed above and any maximum strength listed above that is greater than the minimum strength and may be time-dependent. In some embodiments, the radio frequency field may have a strength of from about 10 kA/m to about 100 kA/m. In one particular embodiment, the radio frequency filed can have a strength of 24 kA/m.

In some embodiments, the radio frequency fields noted above and/or warming procedure (e.g., involving the mNPs) may be applied/conducted for a minimum time of at least 20 seconds such as, for example, at least 30 seconds, at least 50 seconds, at least 70 seconds, at least 90 seconds, at least 110 seconds, or at least 150 seconds. In some embodiments, the radio frequency filed may have a maximum strength of no more than 40 seconds such as, for example, no more than 60 seconds, no more than 85 seconds, no more than 105 seconds, no more than 115 seconds, or no more than 180 seconds. In some embodiments, the strength of the radio frequency field may be characterized as a range having as endpoints any minimum strength listed above and any maximum strength listed above that is greater than the minimum strength and may be time-dependent.

In some embodiments, the sample may be warmed at a minimum rate of at least 0.5° C./sec such as, for example, at least 1° C./sec, at least 5° C./sec, or at least 20° C./sec during warming from below −135° C. to about −30° C. In some embodiments, the biomaterial may be warmed at a maximum rate of no more than 0.5° C./sec such as, for example, no more than 1° C./sec, no more than 5° C./sec, or no more than 20° C./sec during warming from below −135° C. to about −30° C. In some embodiments, the biomaterial may be warmed at a rate within a range having endpoints defined by any minimum rate listed above and any maximum rate listed above that is greater than the minimum rate. In some embodiments, the biomaterial may be warmed at a rate of about 1° C./sec. In other particular embodiments, the biomaterial may be warmed at a rate of about 0.5° C./sec or about 20° C./sec.

In some embodiments, the conventional heating methods may also be used to warm the samples, for example, in combination with nanowarming. Such conventional methods can include, for example, convection and microwave heating. Prior to the methodology of the present disclosure, conventional methodology including convection heating, which heats from the outer boundary, is effective for small vitrified samples but ineffective for large samples (e.g., having a volume greater than 5 mL) due to cryoprotectant cytotoxicity and ice formation during cooling and warming.

In some embodiments, the low radiofrequencies and inductive heating methodologies that may be used to rewarm the samples are those described with respect to biocompatible magnetic nanoparticles, such as, for example, those described in U.S. Patent Application Publication No. 2016/0015025, the disclosure of which is hereby incorporated by reference in its entirety.

In embodiments, the cryopreserved cellular materials preserved by the methods of the present disclosure may be put to any suitable use, including, for example, research or therapeutic uses. For example, regarding therapeutic uses, the cryopreserved cellular materials may be administered to a human or animal patient to treat or prevent a disease or condition such as aortic heart disease, degenerative joint disease, degenerative bone disease, colon or intestinal diseases, degenerative myelopathy, chronic renal failure disease, heart disease, intervertebral disc disease, corneal disease, spinal trauma and replacement of parts lost due to trauma, such as fingers, limb extremities, and faces.

The cryopreserved cellular materials can be administered to a patient in any suitable manner. In some embodiments, the cryopreserved cellular materials may be delivered topically to the patient (e.g. in the treatment of burns, wounds, or skin disorders). In some embodiments, the cryopreserved cellular materials may be delivered to a local implant site within a patient. Any of these or any combination of these modes of administration may be used in the treatment of a patient.

In a first aspect, the present disclosure relates to a method for preserving living large volume cellular material, comprising: exposing the cellular material to a cryoprotectant formulation/solution/medium containing mNPs, subjecting the cellular material to a preservation protocol in which ice-induced damage to the cellular material does not occur, and obtaining a cryopreserved cellular material. In a second aspect the method of the first aspect may be a method in which the cellular material in cryoprotectant solution has a volume greater than 4 mL. In a third aspect, the method of any of the above aspects may be a method in which the volume of the cellular material in cryoprotectant solution is greater than 10 mL. In a fourth aspect, the method of any of the above aspects may be a method in which wherein the cellular material is ice-free for at least 7 days upon subjecting the cellular material to the preservation protocol. In a fifth aspect, the method of any of the above aspects may be a method in which the preservation protocol includes a vitrification strategy that limits the growth of ice during cooling and warming such that ice-induced damage does not occur during the preservation protocol or storage.

In a further aspect, the present disclosure also relates to cryopreserved cellular material obtained by exposure of a living large volume cellular material to a cryoprotectant formulation containing mNPs, and optionally a further cryoprotectant, during a preservation protocol; wherein a cell viability (%) of the cellular material after the preservation protocol is at least 50%, and the cellular material in cryoprotectant solution has a volume greater than 4 mL, such cryopreserved cellular material may be obtained, for example, by a method of any of the above aspects, and may be administered to a patient.

The foregoing is further illustrated by reference to the following examples, which are presented for purposes of illustration and are not intended to limit the scope of the present disclosure.

### EXAMPLES

### Cartilage Experiments

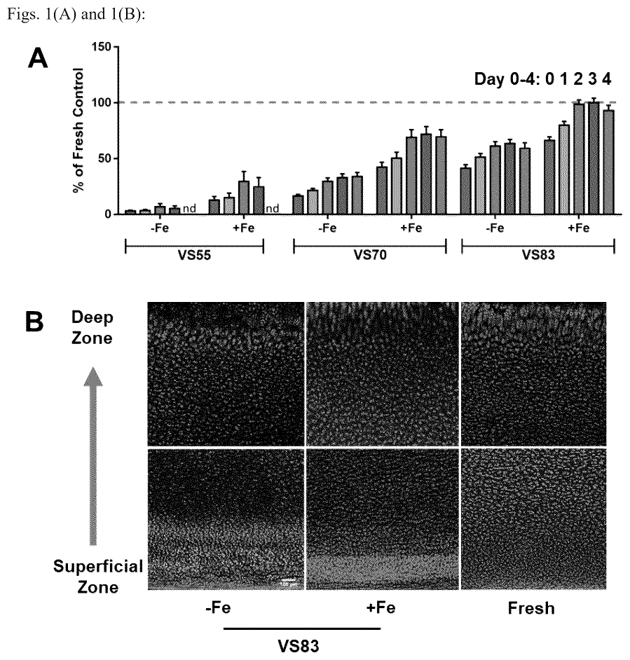

In the following ice-free cryopreservation formulation supplementation experiments, mNPs were added to various vitrification formulations (VS55, VS70, and VS83) in an amount of 2 mg/mL Fe mNPs to access the effectiveness of maintaining chondrocyte viability of porcine articular cartilage in 50 mL systems. The results depicted in FIG. 1 surprisingly demonstrate that the best chondrocyte viability and metabolic activity was observed in the articular cartilage group that was vitrified in the highest 83% CPA formulation (VS83) and rewarmed with 2 mg/mL Fe mNPs.

The inductive heating system settings for nanowarming were 500 Amps and 234 kHz for 80 seconds to warm from below the temperature of −135° C. to −30° C. Longer times and higher settings resulted in overheating and loss of chondrocyte viability.

Regarding the above data, metabolic activity was used as the preliminary screening assay (FIG. 1A), Nanowarmed tissue control and post-warming articular cartilage samples taken from large osteochondral samples were incubated in 2 ml of DMEM culture medium+10% FBS for one hour to equilibrate under physiological conditions, followed by addition of 20% alamarBlue under standard cell culture conditions for three hours. This measurement was performed daily for four days post-rewarming to characterize the metabolic behaviors of the re-warmed cells in the tissues. These results demonstrate that best chondrocyte viability and metabolic activity was observed in the articular cartilage group that was vitrified in the highest 83% CPA formulation (VS83) and rewarmed with 2 mg/mL Fe mNPs. Additionally, after two days, metabolic activity of the nanowarmed tissue was fully recovered to control values (See FIG. 1A).

Regarding the data depicted in FIG. 1B, the Live/Dead Assessment from fresh, convective warming, and nanowarming groups was performed after cutting and staining to assess the chondrocyte distribution across porcine articular cartilage. Images were captured using a two-photon florescent microscope shortly after rewarming. The results (FIG. 1B) demonstrated that, for the nanowarming group (VS83+Fe (2 mg/mL Fe mNPs)), most cells (70-80%) were alive in both the superficial and deep zones, similar to fresh cartilage tissue (90-100%). In contrast, only 30-40% of cells are alive in the convective warming group.

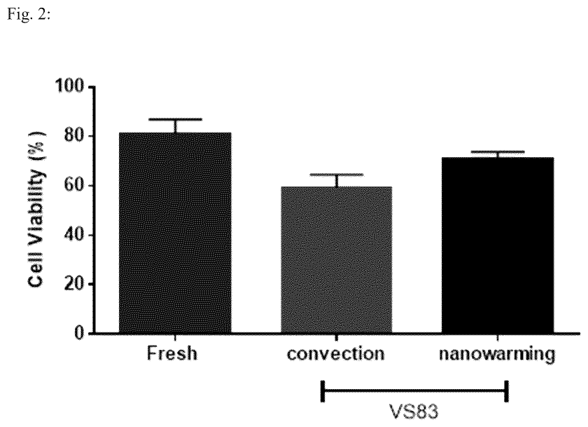

Regarding the data depicted in FIG. 2, Trypan blue exclusion was performed after collagenase digestion.

The results depicted in FIG. 2 demonstrate that live cells could be obtained fresh control cartilage and both convection warmed and nanowarmed cartilage samples (N=4, FIG. 2). There was no significant difference in Trypan blue exclusion between the two warming methods, however there was a statistically significant cell yield difference (p<0.05, t-test) between convection (2.58±0.53×10³ chondrocytes) and nanowarmed with twice as many total cells, both dead and alive being recovered from nanowarmed cartilage (5.97±0.86×10³ chondrocytes). It is hypothesized that cell loss in convection warmed osteochondral grafts is due to ice nucleation damaging cells during rewarming. Using the Trypan blue method the nanowarmed group demonstrated 87.6%±3.4% of fresh viability values.

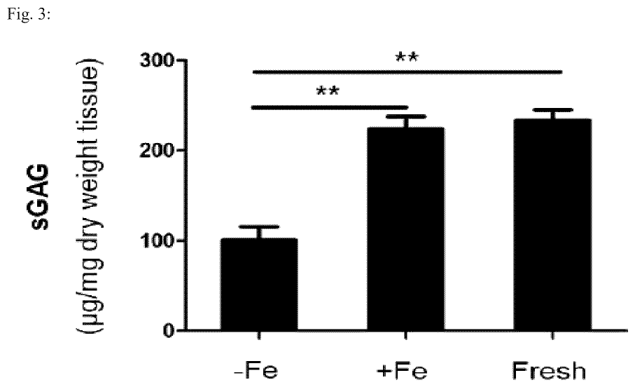

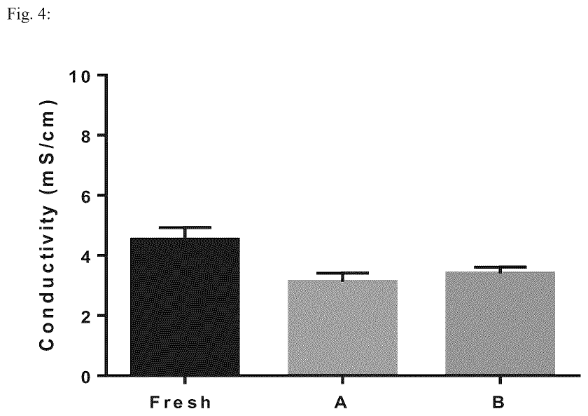

Biomaterial Testing: Glycosaminglycan (GAG) measurement demonstrated statistically significant preservation after nanowarming compared with convection warming (p<0.01) with no differences compared with fresh cartilage (FIG. 3). Permeability was measured using electrical conductivity methods. The tissues were tested under hypotonic and isotonic conditions (n=7-14 samples in N=3 experiments. No significant differences were observed using hypotonic testing (FIG. 4). Statistically significant (p<0.05) slower conductivity was observed under isotonic conditions (not shown) probably due tissue dehydration by the CPAs used. There was no difference in fixed energy charge between the groups because of broad standard deviations in the data.

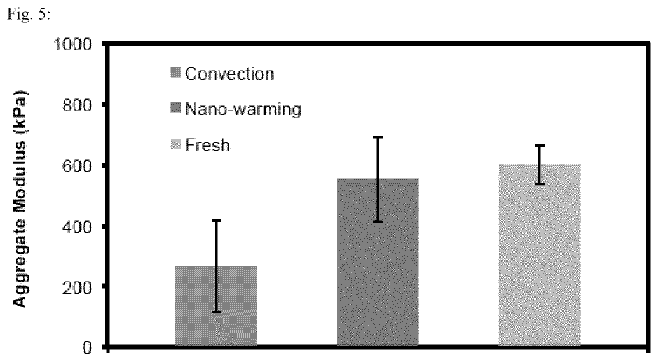

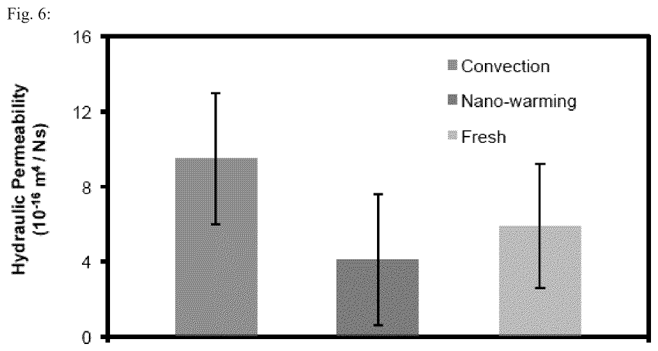

Aggregate modulus and hydraulic permeability were also measured, the results are shown in FIG. 5 and FIG. 6.

The aggregate modulus results for nanowarmed samples are similar to fresh values, however the hydraulic permeability results for both vitrified groups suggest lower permeability (FIG. 6) in agreement with conductivity measurements in FIG. 5, again suggesting that the cartilage had not fully rehydrated after vitrification.

The data above reflect that nanowarming using mNPs (such as 2 mg/mL Fe mNPs) in the VS83 CPA formulation resulted in improved viability compared with convection warming using 3 methods (see, for example, FIGS. 1 and 2). The alamarBlue method is not destructive so the recovery in tissue culture was followed for 4 days. The tissue exposed to the VS83 CPA formulation achieved fresh values (100%) on day 2 of tissue culture (FIG. 1A). The biomaterial testing demonstrated reduced permeability by conductivity and hydraulic permeability measurements. Both GAG content and aggregate modulus were similar to fresh cartilage values (FIGS. 3 and 5).

### Methods

Porcine Articular Cartilage Procurement: Samples were obtained from animals employed in other IACUC approved research studies or from a food processing plant post-mortem. The tissues were dissected, rinsed and placed in sterile cups with ice-cold tissue culture medium containing antibiotics overnight and then allocated for in vitro studies.

Vitrification Method (described with respect to the VS55 samples (VS70 and VS83 were vitrified in a similar manner): Tissues were gradually infiltrated with VS55 consisting of 3.10 M DMSO, 3.10M formamide, and 2.21 M propylene glycol in Euro-Collins solution at 4° C. using methods previously described. Precooled dilute vitrification solutions (4° C.) are added in five sequential 15-min steps of increasing concentration on ice. The last cryoprotectant concentration with 2 mg/mL Fe mNPs dispersed therein was added in a final sixth addition step in either precooled −10° C. or 4° C. full strength vitrification solution and kept in a −10° C. bath for 15 minutes or at 4° C. on ice in plastic tubes. The samples were then cooled in two steps, first rapid cooling to −100° C. by placing in a precooled 2-methylbutane bath at −135° C. and then by transfer to vapor phase nitrogen storage for slower cooling to below −135° C. Finally, the samples were stored below −130° C. in vapor phase nitrogen for at least 24 h before testing.

Warming: Warming was performed by either convection warming or nanowarming. Convection warming is a two-stage process including slow warming to −100° C. and then as rapid as possible warming to melting. The slow warming rate is created by taking the sample to the top of the −135° C. freezer and the control warming rate is generated by placing the plastic container in the mixture of 30% DMSO/H₂O at room temperature. After rewarming, the vitrification solution was removed in a stepwise manner on ice to keep the tissues cold and minimize cytotoxicity due to the presence of residual cryoprotectants.

### Pulmonary Arteries Experiments

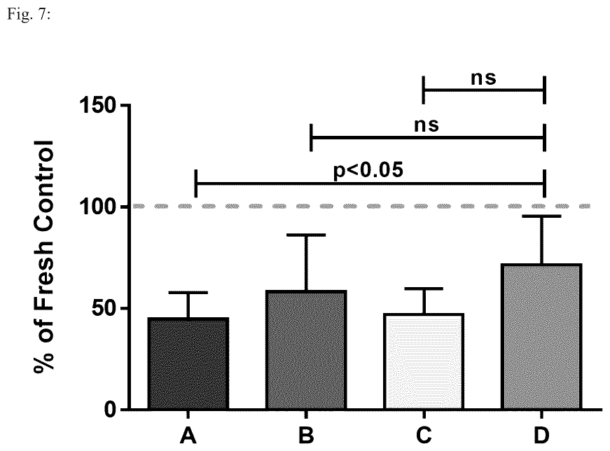

Testing of cryoprotectant (CPA) formulations with disaccharides±mNPs on pulmonary arteries. Disaccharides are an important supplement to the vitrification formulations of the present disclosure. Four formulations were evaluated, three with 0.6M sucrose and one with a combination of 0.3M sucrose with 0.3M trehalose (FIG. 7). Specifically, in FIG. 7 the formulations were prepared as follows: A) load with DP6+0.6M sucrose and vitrify with DP7+0.6M sucrose; B) load with DP7+0.6M sucrose and vitrify with DP7+0.6M sucrose; C) load with DP7+0.6M sucrose and vitrify with DP8+0.6M sucrose; and D) load with DP7+0.3M sucrose+0.3M trehalose and vitrify with VS55+0.3M sucrose+0.3M trehalose. Group D was significantly different compared with Group A (p<0.05, T test), there were no significant (NS) differences for comparisons with Groups B and C. Although not statistically significant the best outcome was obtained using VS55 supplemented with sucrose and trehalose (FIG. 7).

Prolonged exposure to CPA solutions at subzero temperatures (subzero to minimize risks of cytotoxicity) were tested. The last cryoprotectant loading step was compared at 0 and −10° C. in early experiments±Fe and nanowarming. The results were not conclusive, therefore −10° C. was used in all experiments to err conservatively on the safe side to minimize risks of cytotoxicity to the cells in the arteries.

Exposure to very high concentrations of CPA followed by preservation in the presence of lower less toxic concentrations were also tested. Outcome: VS83 and VS70 (83 and 70% cryoprotectants) were evaluated for loading followed by vitrification with VS55+0.3M sucrose+0.3M trehalose. Vitrification with high cryoprotectant loading concentrations resulted in <33% tissue viability (results not shown). Therefore this strategy was discontinued. Alternative strategies using lower concentration loading formulations without formamide were evaluated. The loading was performed in a stepwise manner including disaccharides in the last loading step. Then the loading solution was replaced with one of four vitrification formulations and the arteries were vitrified (FIG. 7). Group D (load with DP7+0.3M sucrose+0.3M trehalose and vitrify with VS55+0.3M sucrose+0.3M trehalose) had the highest mean viability value.

Group D (DP7+0.3M sucrose+0.3M trehalose in the last loading step and then vitrified with VS55+0.3M sucrose+0.3M trehalose) was selected for further stability studies after 0-6 months of storage using physical and biological material characterization methods.

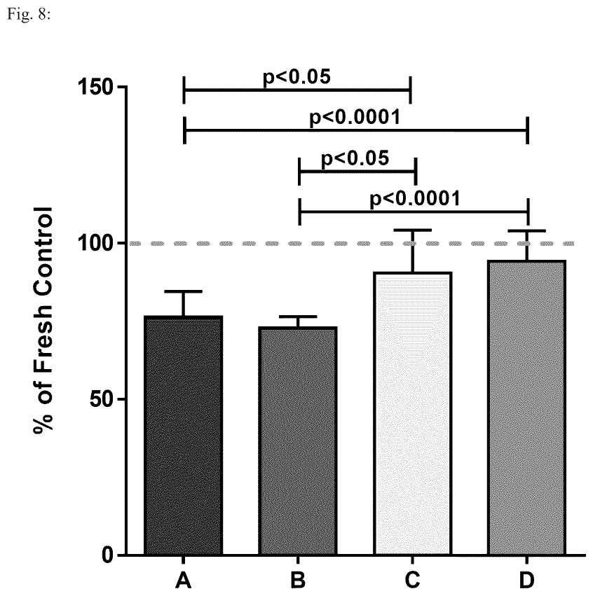

As shown in FIG. 8, nanowarming using the above-mentioned formulation (Group A) with a modification to the same protocol in which sugars were employed to pre-dehydrate the arteries prior to cryoprotectant exposure (FIG. 8, Group B) in order to facilitate more rapid cryoprotectant loading were tested. Neither strategy reached >90% viability (76 and 72% viability, respectively). An alternative post rewarming strategy in which a post-rewarming supplementation procedure was combined with the VS55+0.3M sucrose and 0.3M trehalose and nanowarming with 2.5 mg/mL Fe nanoparticles was also tested. The nanowarmed arteries were incubated under physiological conditions in the presence of an antioxidant, α-tocopherol (vitamin E), and Q-VD-OPH (QVD). This strategy increased the viability to >90% viability at both the short and longer 3 month time points (FIG. 8). Long term storage with convection warming (mean 68.5% of fresh control) was significantly less (p<0.0001 by ANOVA and T-test, not shown) than Group D at 3 months with nanowarming.

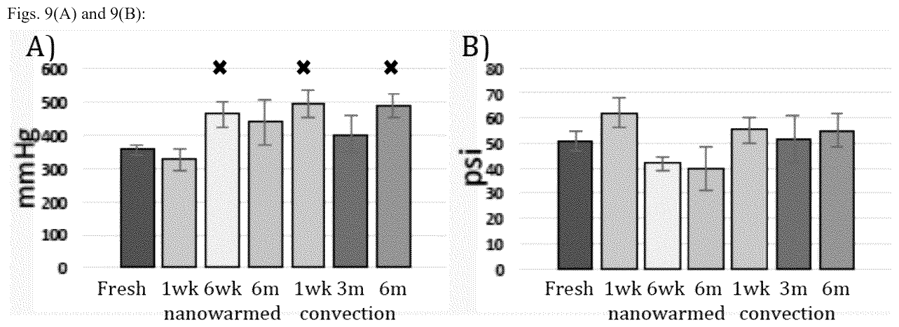

Biomaterials testing was on pulmonary arteries post-rewarming was initiated once it was confirmed that viability was preserved at <90% (FIG. 9). The primary objective was to determine whether the burst pressure (of the arteries) was changed. The burst pressure (A, mmHg) and linear modulus (B, PSI) of fresh versus ice-free vitrified arteries was assessed after storage and warming using either nanowarming or convection in a 37° C. bath. The results are the mean±1 se of 5-8 individual pulmonary arteries, statistically significant increases by two-tailed T-test compared with fresh untreated controls are indicated by X. No other significant differences were observed.

It was determined that there was no significant decrease (P<0.05) in either modulus or burst pressure compared with fresh untreated control arteries over 6 months of storage. As seen in FIG. 9, in some cases (statistically significant, P<0.05 (two tailed T-test)), the vitrified cryopreserved arteries had a higher burst pressure than fresh untreated controls.

### Methods

Tissue Procurement: Bonafide excess tissue blood vessels was obtained from pigs from a local USDA inspected meat processing plant. The arteries were partially dissected, rinsed and placed in sterile ice-cold procurement solution (Hanks Balanced Salt Solution) and transported to the laboratory for further in vitro or in vivo studies. The pulmonary arteries were further dissected upon receipt at the laboratory and placed in sterile cups with Dulbecco's Modified Eagle's Medium (DMEM) and antibiotics. Bonafide excess tissues will not be used in transplant studies due to higher risk of microbial contamination.

Vitrification Method: Tissues were gradually infiltrated with either VS55 consisting of 3.10 M DMSO, 3.10M formamide, and 2.21 M 1,2-propanediol±≤0.6M disaccharides in Euro-Collins solution at 4° C. or equimolar concentrations (3.5M) of DMSO and 1,2-propanediol to make DP7±≤0.6M disaccharides. The first loading steps with the DP7 strategy were without disaccharides and then DP7+0.3M sucrose+0.3M trehalose and finally vitrification with VS55+0.3M sucrose+0.3M trehalose. Disaccharides may be sucrose, trehalose either alone or combined. Precooled dilute vitrification solutions (4° C.) were added in five sequential 15-min steps of increasing concentration on ice. Magnetic nanoparticles (2.5 mg/mL Fe, EMG-308 supplied by Ferrotec) were added in the final sixth addition step in precooled −10° C. full strength vitrification solution and kept in a −10° C. bath for 15 minutes in 50 mL plastic tubes. The samples were then cooled in two steps, first rapid cooling to −100° C. by placing in a precooled 2-methylbutane bath at −135° C. and then transfer to vapor phase nitrogen for slower cooling to and storage below −135° C. for at least 24 h before testing. In some embodiments, the effective concentration range for the nanoparticles may be in the range of from about 0.5 to about 10 mg/mL Fe, such as about 1.5 to about 5 mg/mL Fe, or 2.0 to about 3 mg/mL Fe.

Rewarming Methods: Vitrified blood vessels were rewarmed using either convection or nanowarming after various storage times at ≤−135° C. Convection warming is a two-stage process including slow warming to −100° C. and then as rapid as possible warming to melting. The slow warming rate is created by taking the sample to the top of the −135° C. freezer and the more rapid warming rate is generated by placing the plastic sample container in a mixture of 30% DMSO/H2O at room temperature. Nanowarming was performed by inserting the samples into the radio frequency coil and heated by induction. The tests described above employed a 6.0 kW induction terminal, however other suitable induction terminal may also be employed. After rewarming, the mNPs were removed from the sample tubes and cryoprotectants removed in a stepwise manner. A post rewarming incubation step with antioxidants and/or antiapoptotic agent supplements may also be introduced if reperfusion injury results in loss of cell viability/function.

Post Rewarming Recovery was performed by incubation under physiological conditions in the presence of an antioxidant and an apoptosis inhibitor, 100 μM α-tocopherol (vitamin E) and 10 μM Q-VD-OPH (QVD). In some embodiments, the effective concentration range for the antioxidant may be in the range of from about 0.5 μM to about 1000 μM, such as about 5 μM to about 500 μM, or 50 μM to about 200 μM. In some embodiments, the effective concentration range for the apoptosis inhibitor may be in the range of from about 0.1 μM to about 100 μM, such as about 1 μM to about 50 μM, or 5 μM to about 20 μM.

Additional exemplary supplements and/or additives that may be added to the formulations of the instant disclosure and/or used in the methodology of the instant disclosure are listed in Table I (above).

Viability Assessment: Metabolic activity of pulmonary arteries was assessed using the alamarBlue™ resazurin assay. Tissue samples were incubated in DMEM+10% FBS culture medium for one hour to equilibrate followed by the addition of 20% alamarBlue under standard cell culture conditions for 3 hours. The DMEM was supplemented with 100 μM α-tocopherol (vitamin E) and 10 μM Q-VD-OPH (QVD) in later studies resulting in >90% tissue cell viability. AlamarBlue is a non-toxic fluorometric indicator based on detection of metabolic activity. Fluorescence was measured in aliquots at an excitation wavelength of 544 nm and an emission wavelength of 590 nm.

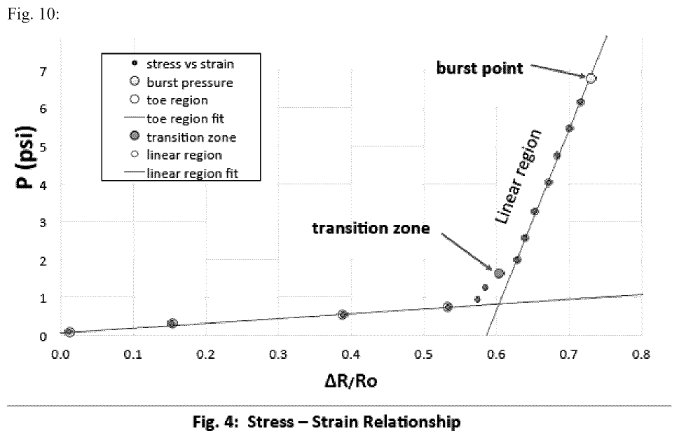

Biomaterials testing: Pressure data (psi) was plotted against radial strain yielding a stress-strain curve typical of soft tissue deformation (typical curve FIG. 10). The linear region was used to generate a best line fit yielding the linear modulus (mmHg). The maximum pressure recorded prior to rupture was used to estimate burst pressure (PSI).

All literature and patent references cited throughout the disclosure are incorporated by reference in their entireties. Although the preceding description has been described herein with reference to particular means, materials and embodiments, it is not intended to be limited to the particulars disclosed herein; rather, it extends to all functionally equivalent structures, methods and uses, such as are within the scope of the appended claims. Furthermore, although only a few example embodiments have been described in detail above, those skilled in the art will readily appreciate that many modifications are possible in the example embodiments without materially departing from the disclosure of ICE-FREE VITRIFICATION AND NANOWARMING OF LARGE TISSUE SAMPLES. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A method for preserving living large volume cellular material, comprising:
exposing the living large volume cellular material to a solution of a high concentration cryoprotectant formulation;
obtaining a cryopreserved cellular material from the exposed cellular material by subjecting the exposed cellular material to a preservation protocol in which damage to the exposed cellular material due to freezing does not occur; and
nanowarming the cryopreserved cellular material such that metabolic activity of the nanowarmed tissue is recovered to in a range of 70% to 100% of control values within two days of being rewarmed, the control values corresponding to metabolic activity of fresh cellular material, which was not cryopreserved, in a growth media,
wherein the total concentration of the Fe mNPs in the high concentration cryoprotectant formulation is in the range of from 2 mg/mL to 3 mg/mL,
wherein a cryoprotectant agent concentration in the high concentration cryoprotectant formulation is in a range of 75% to 83%, and
wherein the high concentration cryoprotectant formulation consists of 3.10 mol/L dimethyl sulfoxide, 3.10 mol/L formamide, and 2.21 mol/L 1,2-propanediol+0.6 mol/L disaccharides (0.3 mol/L sucrose+0.3 mol/L trehalose) in 1× EuroCollins solution.

2. The method of claim 1, wherein the living large volume cellular material in the solution of the high concentration cryoprotectant formulation has a volume greater than 10 mL.

3. The method of claim 1, wherein the preservation protocol includes vitrification that limits the growth of ice during cooling and warming such that the damage due to freezing does not occur during the preservation protocol.

4. The method of claim 1, wherein subjecting the exposed cellular material to a preservation protocol comprises:
stepwise cryoprotectant addition to the high concentration cryoprotectant formulation to achieve a final cryoprotectant formulation with a cryoprotectant concentration effective to avoid the damage to the exposed cellular material due to freezing.

5. The method of claim 1, wherein the living large volume cellular material is selected from the group consisting of human organs and human tissues.

6. The method of claim 1, wherein the living large volume cellular material is cartilage.

7. The method of claim 1, wherein a cell viability (%) of the cryopreserved cellular material after completion of the preservation protocol is at least 70%.

8. The method of claim 1, wherein a cell viability (%) of the cryopreserved cellular material after completion of the preservation protocol is at least 80%.

9. The method of claim 1, wherein the high concentration cryoprotectant formulation has a cryoprotectant molarity of no less than 11 M.

10. The method of claim 1, wherein the cryopreserved cellular material is nanowarmed during the preservation protocol via subjecting the cryopreserved cellular material that has been cryopreserved to electromagnetic energy of an intensity sufficient to excite the Fe mNPs and thaw the cryopreserved cellular material.

11. The method of claim 10, wherein the electromagnetic energy comprises a radio frequency field, an alternating magnetic field, or a rotating magnetic field.

12. The method of claim 11, wherein the radio frequency field, alternating magnetic field, or rotating magnetic field comprises a frequency of 200 kHz to 250 kHz.

13. The method of claim 12, wherein the living large volume cellular material is exposed to the high concentration cryoprotectant formulation via perfusion with the high concentration cryoprotectant formulation.

14. A method for preserving living large volume cartilage tissue, the method comprising:
exposing the living large volume cartilage tissue to a solution of a high concentration cryoprotectant formulation;
obtaining a cryopreserved cartilage tissue from the exposed cartilage tissue by subjecting the exposed cartilage tissue to a preservation protocol in which damage to the cartilage tissue due to freezing does not occur; and
nanowarming the cryopreserved cartilage tissue such that metabolic activity of the cartilage tissue is recovered to in a range of 70% to 100% of control values within two days of being rewarmed, the control values corresponding to fresh cartilage tissue, which was not cryopreserved, in a growth media,
wherein the total concentration of the Fe mNPs in the high concentration cryoprotectant formulation is in the range of from 2 mg/mL to 3 mg/mL,
wherein a cryoprotectant agent concentration in the high concentration cryoprotectant formulation is in a range of 75% to 83%, and
wherein the high concentration cryoprotectant formulation consists of 3.10 mol/L dimethyl sulfoxide, 3.10 mol/L formamide, and 2.21 mol/L 1,2-propanediol+0.6 mol/L disaccharides (0.3 mol/L sucrose+0.3 mol/L trehalose) in 1× EuroCollins solution.

15. The method of claim 14, wherein the living large volume cartilage tissue in the solution of the high concentration cryoprotectant formulation has a volume greater than 10 mL.

16. The method of claim 15, wherein a cell viability (%) of the cryopreserved cartilage tissue after completion of the preservation protocol is at least 80%.

17. The method of claim 16, wherein the nanowarming step includes performing nanowarming using an inductive heating system that nanowarms at 500 Amps and 234 kHz for 80 seconds to warm the cryopreserved cartilage tissue from below −135° C. to −30° C.

18. The method of claim 1, wherein the nanowarming step includes rewarming the cryopreserved cellular material with 2 mg/mL Fe and the metabolic activity of the nanowarmed tissue is fully recovered to control values within two days of being rewarmed.
